(19) United States
(12) Patent Application Publication
(10) Pub. No.: US 2022/0414655 A1
(43) Pub. Date: Dec. 29, 2022

(54) SYSTEMS AND METHODS FOR PRIVATE NODE-LEVEL DATA COMPUTING AND RECONCILIATION

(71) Applicant: Jiko Group, Inc., New York, NY (US)

(72) Inventors: Stephane Lintner, Glen Cove, NY (US); Andrea G. Forte, Brooklyn, NY (US); Hannes Helgason, Reykjavik (IS); Rocky Motwani, New York, NY (US)

(73) Assignee: Jiko Group, Inc., New York, NY (US)

(21) Appl. No.: 17/899,299

(22) Filed: Aug. 30, 2022

Related U.S. Application Data
(63) Continuation of application No. 15/875,849, filed on Jan. 19, 2018.
(60) Provisional application No. 62/448,689, filed on Jan. 20, 2017.

(51) Int. Cl. G06Q 20/38; G06Q 30/06; G06Q 40/02; H04L 9/40; G06Q 20/40; G06F 21/42; H04L 9/32; G06Q 40/04; G06Q 40/06

(52) U.S. Cl. CPC G06Q 20/3829; G06Q 20/38215; G06Q 30/06; G06Q 40/02; H04L 63/0428; G06Q 20/401; H04L 63/12; G06F 21/42; H04L 9/3236; G06Q 20/383; G06Q 20/3825; G06Q 40/04; G06Q 40/06; H04L 2209/56; H04L 2463/102; H04L 9/50

(57) ABSTRACT

Aspects and embodiments are directed to method and system for node based reconciliation. Various aspects also provide for real-time securities exchange while supporting cash based transactions. Additional aspects incorporate improved user interfaces for enabling single selection investment decisions for all of a clients' wealth.

### RELATED APPLICATIONS

This application is a Continuation of and claims priority under U.S.C. § 120 to U.S. application Ser. No. 15/875,849, entitled “SYSTEMS AND METHODS FOR PRIVATE NODE-LEVEL DATA COMPUTING AND RECONCILIATION”, filed Jan. 19, 2018, which claims priority under 35 U.S.C. § 119(e) to U.S. Provisional Application Ser. No. 62/448,689, entitled SYSTEMS AND METHODS FOR PRIVATE NODE-LEVEL DATA COMPUTING AND RECONCILIATION, filed on Jan. 20, 2017, each of which are herein incorporated by reference in their entirety.

### BACKGROUND

Various conventional approaches exist to provide secure transactional, communication and computational platforms. Typically, such systems rely on large centralized ledgers, centralized databases and centralized servers for, respectively, the reconciliation of transactional information, routing of sensitive information (including payments and investment decisions), and the dynamic manipulation of large sensitive datasets (e.g. fraud, AML detection and other calibrations). The centralized nature of traditional approaches concentrate security flaws in a few critical points of failure. Centralized systems also present challenges to deploy and evolve software components in an agile manner, given that any change immediately affects the entirety of the system (and the users). As far as transactions are concerned, various blockchain methods have been deployed recently, but those require proof-of-work to validate the distribution, a highly intensive and costly approach.

### SUMMARY

It is realized that there is a need for distributed reconciliation systems that do not rely on proof of work or centralized ledgers, and there is further need for highly private implementations. According to various aspects, novel systems and methods are provided as part of this set of applications for secure, low-cost distributed private data computation, private banking transaction processing and/or investment management. Various embodiments eliminate the need for proof of work and/or centralized ledgers improving security over conventional approaches. In some embodiments, computation and execution of transactions occurs with fewer operations (e.g., system computations) than conventional approaches. Utilizing fewer operations in distributed data computations improves the executional efficiency of the system of various conventional approaches. In yet other embodiments, the system handles system base and user level privacy while guarantying proper execution and monitoring for fraud or improper activity. Maintaining system privacy in these is a function that many conventional approaches cannot execute.

According to one embodiment, the systems and methods implement a core infrastructure that includes a unique node level architecture. In this architecture, each user of the system has private resources created and assigned to that respective user, and referred to as a ‘node’, which is configured to manage all of the user's transactions and data manipulations both securely and anonymously. In one embodiment, a node has the full technical power of a traditional enterprise back-end, including, for example, firewalls implemented for that node, secured authenticated access points for and to the node, a dedicated database for the node, among other options. In various embodiments, the node houses all of the customer's data (e.g., personal, transactional, etc.), and the node is enabled to manipulate that data locally, and therefore to power some of the most private functionalities for that user (such as e.g., banking or investment functions which require direct access to the user's very personal data (financial history, health, assets on record)) while preserving privacy for that user and generating verifiable (but anonymous) records.

In another example, each user is given a private “node” or private server that is provisioned in the cloud and configured to manage all their transactions both securely and anonymously, by relying on a set of anonymous reconciliation algorithms. According to one embodiment, a node is configured with a software development kit (SDK) allowing the deployment of 3^{rd} party modules that can run natively in the user's node. In various embodiments, the user is able to choose which modules to install, and what data those modules accesses. In some examples, the system provides a user interface and associated display listing available modules. The user can select within the display to integrate various modules and activate the associated functionality while preserving security and anonymity.

In other embodiments, the underlying architecture has been adapted to many scenarios where anonymity and security are valued (e.g., health care management and/or provisioning, medical advertisement, electronic medical record management, lending applications, etc.). In those embodiments, the system's architecture is natively able to implement differential privacy computations. For example, given a need to compute the average age of all users to which a node has been assigned, and assume each node privately stores that information (e.g., age). The system can be configured to send a request to all nodes to provide an input to the computation. Each node then computes its value (in this case just lookup the age which is stored locally) and then adds some random noise to the value (e.g., a large value). According to some embodiments, then all nodes publish their result to a collector. The collector receives noisy results from each node—that is each message individually carries no usable information. For example, if an adversary intercepts the message coming from node_51, it may be −23, e.g., the age of the user (arbitrarily assign as 13) with noise on top (a number between −100 and 100 randomly chosen by the node) in this case −46. Thus, the only information captured by the adversary is that node 51 published −23, which is useless. But the collector can then apply an average to all the numbers collected and as long as a threshold number (e.g., more than 10,000 numbers have been collected) of nodes respond via publication to the collector the average will represent the true average age of the users within 2 digits of accuracy. In this example, the execution of an obscured simple averaging technique is describe, but other operations and information collection functions can be based on the same principal to preserve privacy for individual nodes by crafting noisy responses, that can be used in the aggregate to eliminate the noise within a certain degree of error.

The functions and approaches of the architecture are discussed below with respect to financial services for illustration, but other embodiment implement the same or similar functions in other technical environments.

According to one aspect, a node based reconciliation system is provided. The system comprises: at least a first node associated with a first client, wherein the first node includes: a private ledger or record for the first client, wherein the private ledger is the single source for an entire transaction history for the first client; a database including key based addresses for information required to communicate with other nodes associated with other clients (e.g., authorized clients), including a wallet of addresses or keys used to sign or receive transactions from a central record; wherein the first node is configured to execute reconciliation between a pair of nodes, the execution including functions to: establish a secure connection based on the database information for the other nodes in the system; modify the private ledger based on a key for the first node and a monetary value; release the monetary value to the other node based on a respective key for the other node; and cryptographically sign and publish a portion of an anonymous public record specifying acceptance of the transfer to the other node.

According to one embodiment, the system further comprises a second node having: a private ledger for the second client, wherein the private ledger is the single source for an entire transaction history for the second client; a database including information required to communicate with other nodes associated with other clients, including a wallet of addresses and/or keys used to sign and/or receive transactions from a central record; and wherein the second node is configured to cryptographically sign and publish a remaining portion of an anonymous public record specifying acceptance of a transfer between the first and the second node. According to one embodiment, the system further comprises an administration node configured to manage provisioning of a node and association of the respective node with a single client.

According to one embodiment, the administration node is further configured to provision firm-side nodes configured to: interface with external channels (e.g., Credit Card processing networks, ACH, Check, etc.); and transform transactions into key and monetary value reconciliation objects.

According to one aspect, a node based investment system is provided. The system comprising: at least a first node associated with a first client, wherein the first node includes: a private ledger for the first client, wherein the private ledger is the single source for an entire transaction history for the first client (e.g., stored as initiator key and monetary value and recipient key and monetary value); an monetary (e.g., bank) account associated with the private ledger; a broker account associated with a trading component; the trading component executing on the first node, configured to: monitor any available balance in the monetary account; and responsive to identifying a positive balance, generate automatically an investment purchase based on any existing securities and the investment purchase meeting a defined risk parameter, wherein the generation of the investment purchase includes calculation and optimizes for a cost of liquidation of at least a portion of the existing securities and the investment purchase to meet subsequent transactions (e.g., debits) on the monetary account; transfer funds between the monetary account and the broker account based on key and monetary value pair exchange and validation; and execute the investment purchase.

According to one embodiment, the trading component is further configured to monitor requests for funds on the monetary account; respond to requests for portfolio valuations of the existing securities (e.g., the whole portfolio, funds, stocks, ETF, bonds, etc.); responsive to identifying sufficient funds to meet a request on the monetary account, calculate a liquidation of at least some assets to the request, wherein the calculation of the at least some assets includes execution of functions to determine the at least some assets to preserve the defined risk parameter and to determine a minimal transactional cost of the liquidation; execute the liquidation; and transfer funds between the monetary account and the broker account based on key and monetary value pair exchange and validation.

According to one aspect a system for displaying a user interface is provided. The system comprising: at least one processor operatively connected to a memory, the memory containing instructions, the instructions when executed that cause the user interface to: display an enrollment options for real-time security investment; display a moveable interface object, the moveable interface object responsive to positioning in the user interface is configured to define a risk parameter; upon user input on the moveable interface object, trigger a trading component to define an investment purchase meeting the defined risk parameter, wherein the generation of the investment purchase includes calculation and optimization for a cost of liquidation of at least a portion of the existing securities and the investment purchase to meet subsequent transactions (e.g., debits) on the monetary account; and the trading component further configured to automatically execute the investment purchase.

According to one aspect anode based reconciliation system is provided. The system comprises at least a first node, executed by at least one processor, associated with a first client, wherein the first node includes: a private record for the first client, wherein the private record is configured for access only on the first node and by first client and is the single source for a transaction history for the first client; a database including key based addresses storing for information required to communicate with other nodes in the reconciliation system associated with other clients (e.g., authorized clients), including a wallet of addresses or keys used to sign, receive and validate transactions on a central record; wherein the first node is configured to execute reconciliation between a pair of nodes, the reconciliation including execution of functions configured to: establish a secure connection based on the database information for the other nodes in the system with a second node; modify the private record based on a key for the first node and a value associated with a transaction; allocate the value between the first node and the second node based on a respective key for the second node; and cryptographically sign and publish at least a portion of an anonymous public record specifying acceptance of the transfer between the respective nodes. According to one embodiment, the system further comprises the second node, executed by at least one processor, having: a second private record for the second client, wherein the second private record is configured for access only on the second node and second client and is the single source for a transaction history for the second client; a second database including information required to communicate with other nodes associated with other clients, including a wallet of addresses and/or keys used to sign and/or receive and validate transactions from a central record; and wherein the second node is configured to cryptographically sign and publish a remaining portion of an anonymous public record specifying acceptance of a transfer between the first and the second node. According to one embodiment, the system further comprises an administration node configured to manage provisioning of a node and association of the respective node with a single client. According to one embodiment, the administration node is further configured to provision firm-side nodes configured to: interface with external channels (e.g., Credit Card processing networks, ACH, Check, etc.); and transform transactions into key and monetary value reconciliation objects. According to one embodiment, the reconciliation system is configured to limit external transactions (e.g., originating or terminating outside of the reconciliation system (e.g., not a Jiko node) to pathways that are mediated by firm-side nodes. According to one embodiment, the system further comprises a firm side-node configured to manage external (e.g., outside reconciliation system) transactions. According to one embodiment, the firm side node is configured to: manage communication with external payment processes (e.g., PayPal, Bitcoin exchange markets, external broker accounts, banks, ACH, credit card, etc.); manage credits and debits on a private external account record based on record key and value pairs; publish an anonymous record validating any credit or debit to the private external account signed with an associated key. According to one embodiment, the firm side node includes: a firm side database including information required to communicate with other nodes each associated with other clients within the reconciliation system, including a wallet of addresses and/or keys used to sign and/or receive and validate transactions with a central public record; and wherein the firm node is configured to cryptographically sign and publish at least a portion of an anonymous public record specifying acceptance of a transfer between the firm node and first and the second node. According to one embodiment, the system further comprises a monitoring process configured to: record established communication channels to respective nodes in the reconciliation system; and record metrics on network traffic. According to one embodiment, the monitoring process is further configured to: identify abnormal traffic conditions on one or more nodes (e.g., higher traffic volume, network traffic exceeding threshold (e.g., per connection and/or average), unusual connections, direct external source connection, etc.); trigger reduced functionality (e.g., reporting only, no transaction execution, or pause existing transactions, etc.) state for the one or more nodes.

According to one aspect a computer implemented method for node based reconciliation is provided. The method comprises: maintain, by a first node in a reconciliation network, a private record for a first client, wherein the private record is configured for access only on the first node and by first client and is the single source for a transaction history for the first client; generate, on the first node, a database including key based addresses storing for information required to communicate with other nodes in the reconciliation system associated with other clients (e.g., authorized clients), including a wallet of addresses or keys used to sign, receive and validate transactions on a central record; reconciling between a pair of nodes including the first node transaction information, wherein the act of reconciliation includes: establishing a secure connection based on the database information for the other nodes in the system with a second node; modifying the private record based on a key for the first node and a value associated with a transaction; allocating the value between the first node and the second node based on a respective key for the second node; and cryptographically signing and publishing at least a portion of an anonymous public record specifying acceptance of the transfer between the respective nodes. According to one embodiment, the method further comprises: maintaining at the second node, a second private record for the second client, wherein the second private record is configured for access only on the second node and second client and is the single source for a transaction history for the second client; and generating, at the second node, a second database including information required to communicate with other nodes associated with other clients, including a wallet of addresses and/or keys used to sign and/or receive and validate transactions from a central record wherein the second node is configured to cryptographically sign and publish a remaining portion of an anonymous public record specifying acceptance of a transfer between the first and the second node. According to one embodiment, the method further comprises managing, by an administration node, provisioning of a node and association of the respective node with a single client. According to one embodiment, the method further comprises provisioning firm-side nodes configured to: executing by the firm-side node connections with external channels (e.g., Credit Card processing networks, ACH, Check, etc.); and transforming transactions with the external channels into key and monetary value reconciliation objects. According to one embodiment, the method further comprises limiting external transactions (e.g., originating or terminating outside of the reconciliation system (e.g., not a Jiko node)) to pathways that are mediated by firm-side nodes. According to one embodiment, the method further comprises managing, by a firm side-node, external (e.g., outside reconciliation system) transactions. According to one embodiment, the method further comprises managing, by the firm-side node communication with external payment processes (e.g., PayPal, Bitcoin exchange markets, external broker accounts, banks, ACH, credit card, etc.); managing credits and debits on a private external account record based on record key and value pairs; and publishing an anonymous record validating any credit or debit to the private external account signed with an associated key. According to one embodiment, the method further comprises maintaining a firm side database including information required to communicate with other nodes each associated with other clients within the reconciliation system, and including a wallet of addresses and/or keys used to sign and/or receive and validate transactions with a central public record wherein the firm node is configured to cryptographically sign and publish at least a portion of an anonymous public record specifying acceptance of a transfer between the firm node and first and the second node. According to one embodiment, the method further comprises monitoring established communication channels to respective nodes in the reconciliation system; and recording metrics on network traffic. According to one embodiment, monitoring includes: identifying abnormal traffic conditions on one or more nodes (e.g., higher traffic volume, network traffic exceeding threshold (e.g., per connection and/or average), unusual connections, direct external source connection, etc.); and triggering reduced functionality (e.g., reporting only, no transaction execution, or pause existing transactions, etc.) state for the one or more nodes.

According to one aspect a node based clearing system is provided. The system comprises at least a first node associated with a first client, wherein the first node includes: a private record for the first client, wherein the private record provides a single source for a transaction history for the first client (e.g., stored as initiator key and monetary value pair and recipient key and monetary value that collectively define a balance); a monetary (e.g., bank) account associated with the private record; a broker account associated with a trading component executed by the first node; the trading component executing on the first node, configured to: monitor dynamically any available balance in the monetary account; and responsive to identifying a positive balance, generate automatically an investment purchase based on any existing securities and generate an allocation of assets in the investment purchase such that the assets or total holdings of the first client meet a defined risk parameter, wherein the generation of the investment purchase includes calculation and optimization for a cost of liquidation of at least a portion of the existing securities and the investment purchase, such that the optimized selection of assets further minimize a cost associated with meeting any needed value for executing subsequent transactions (e.g., debits) on the monetary account; transfer funds between the monetary account and the broker account based on key and monetary value pair exchange and validation; and execute the investment purchase. According to one embodiment, the first node is further configured to: modify the private record based on a key for the first node and a value associated with the transfer, wherein modifying the private record includes generating an update for the private record based on a transaction key and value pair for the monetary account and a transaction key and value pair for the brokerage account; allocate the value between the monetary account and the brokerage account based on the respective key and value pairs; and cryptographically sign and publish an anonymous public record specifying the transfer between the respective accounts. According to one embodiment, the trading component is further configured to monitor requests for funds on the monetary account; respond to requests for portfolio valuations of the existing securities (e.g., the whole portfolio, funds, stocks, ETF, bonds, etc.); responsive to identifying sufficient funds to meet a request on the monetary account based on the portfolio valuation, calculate a liquidation of at least some assets to the request, wherein the calculation of the at least some assets includes: determining at least some assets in order to preserve the defined risk parameter and to determine a minimal transactional cost of the liquidation; execute the liquidation operation; and transfer results of liquidation operation based on respective key and monetary value pair exchange and validation. According to one embodiment, the trading component is further configured to model reallocation trades, wherein the modelled re-allocation identifies opportunities to reduce future transaction costs associated with asset liquidation (e.g., model future debit transactions against monetary account). According to one embodiment, the trading component evaluates historic transactions against the monetary account and generates models for asset liquidation to meet: a likely transaction request, model for high value transaction request (e.g., high value being a percentage greater than the likely transaction or a standard deviation over the likely transaction (plotting value of historic transaction over time) or a model for a low value transaction request (e.g., low value being a percentage less than the likely transaction or a standard deviation lower than the likely transaction (plotting value of historic transaction over time). According to one embodiment, the trading component is configured to trigger the modelled asset liquidation in response to a debit request and decrease transaction response time over dynamically calculating the asset liquidation. According to one embodiment, the trading component matches a debit to a modelled assets liquidation and executed the matched assets liquidation. According to one embodiment, the system further comprises a firm side node is configured to: manage communication with the first node and external payment processes (e.g., PayPal, Bitcoin exchange markets, external broker accounts, banks, ACH, credit card, etc.); manage credits and debits on a private external account record based on record key and value pairs; publish an anonymous record validating any credit or debit to the private external account signed with an associated key. According to one embodiment, the system further comprises a monitoring process configured to: monitor communication and communication channels with respective nodes in the clearing system; and record metrics on network traffic. According to one embodiment, the monitoring process is further configured to: identify abnormal traffic conditions on one or more nodes (e.g., higher traffic volume, network traffic exceeding threshold (e.g., per connection and/or average), unusual connections, direct external source connection, etc.); trigger reduced functionality (e.g., reporting only, no transaction execution, or pause existing transactions, etc.) state for the one or more nodes.

According to one aspect a method for node based clearing is provided. The method comprises: generating by at least a first node associated with a first client, a private record for the first client, wherein the private record provides a single source for a transaction history for the first client (e.g., stored as initiator key and monetary value pair and recipient key and monetary value that collectively define a balance); establishing for the first node a monetary (e.g., bank) account associated with the private record and a broker account associated with a trading component executed by the first node; dynamically monitoring, by the first node any available balance in the monetary account; and responsive to identifying a positive balance, generating automatically an investment purchase based on any existing securities and generating an allocation of assets in the investment purchase such that the assets or total holdings of the first client meet a defined risk parameter, wherein the act of generating the investment purchase includes acts of: calculating and optimizing for a cost of liquidation of at least a portion of the existing securities and the investment purchase, such that the optimized selection of assets further minimize a cost associated with meeting any needed value for executing subsequent transactions (e.g., debits) on the monetary account; transferring, by the first node, funds between the monetary account and the broker account based on key and monetary value pair exchange and validation; and executing the investment purchase. According to one embodiment, the method further comprises: modifying, by the first node, the private record based on a key for the first node and a value associated with the transfer, wherein modifying the private record includes generating an update for the private record based on a transaction key and value pair for the monetary account and a transaction key and value pair for the brokerage account; allocating the value between the monetary account and the brokerage account based on the respective key and value pairs; and cryptographically signing and publishing an anonymous public record specifying the transfer between the respective accounts. According to one embodiment, the method further comprises: monitoring requests for funds on the monetary account; responding to requests for portfolio valuations of the existing securities (e.g., the whole portfolio, funds, stocks, ETF, bonds, etc.); responsive to identifying sufficient funds to meet a request on the monetary account based on the portfolio valuation, calculating a liquidation of at least some assets to the request, wherein the calculation of the at least some assets includes: determining the at least some assets in order to preserve the defined risk parameter and to determine a minimal transactional cost of the liquidation; executing the liquidation operation; and transferring results of liquidation operation based on respective key and monetary value pair exchange and validation. According to one embodiment, the method further comprises modelling reallocation trades, wherein the modelled re-allocation identifies opportunities to reduce future transaction costs associated with asset liquidation (e.g., model future debit transactions against monetary account). According to one embodiment, the method further comprises evaluating historic transactions against the monetary account, including generating models for asset liquidation to meet: a likely transaction request, model for high value transaction request (e.g., high value being a percentage greater than the likely transaction or a standard deviation over the likely transaction (plotting value of historic transaction over time) or a model for a low value transaction request (e.g., low value being a percentage less than the likely transaction or a standard deviation lower than the likely transaction (plotting value of historic transaction over time). According to one embodiment, the method further comprises triggering the modelled asset liquidation in response to a debit request and decrease transaction response time over dynamically calculating the asset liquidation. According to one embodiment, the method further comprises matching a debit to a modelled assets liquidation and executing the matched assets liquidation. According to one embodiment, the method further comprises: managing, by a firm side node, communication with the first node and external payment processes (e.g., PayPal, Bitcoin exchange markets, external broker accounts, banks, ACH, credit card, etc.); managing, by the firm side node, credits and debits on a private external account record based on record key and value pairs; and publishing, by the firm side node, an anonymous record validating any credit or debit to the private external account signed with an associated key. According to one embodiment, the method further comprises: monitoring communication and communication channels with respective nodes in the clearing system; and recording metrics on network traffic. According to one embodiment, monitoring includes: identifying abnormal traffic conditions on one or more nodes (e.g., higher traffic volume, network traffic exceeding threshold (e.g., per connection and/or average), unusual connections, direct external source connection, etc.); and triggering reduced functionality (e.g., reporting only, no transaction execution, or pause existing transactions, etc.) state for the one or more nodes.

According to one aspect a system for managing a user interface is provided. The system comprises at least one processor operatively connected to a memory, the memory containing instructions, the instructions when executed that cause the at least one processor to: generate a plurality of user interface displays; display at least a first enrollment option screen, for accepting enrollment information into a node based reconciliation and clearing system; trigger creation of a first client node on cloud based resource, the first node including a private ledger, a first account, and broker account; display at least a second enrollment screen to receive user input for activating available real-time security investment functionality; responsive to activation of the security functionality in the second enrollment screen, display a moveable interface object, the moveable interface object responsive to user input to define a positioning in the user interface within a display boundary; define a risk parameter responsive to a user established positioning within the display boundary; trigger a trading component to define an candidate investment meeting the defined risk parameter, wherein the generation of the investment purchase includes calculation and optimization for a cost of liquidation of at least a portion of any candidate investment to meet subsequent transactions (e.g., debits) on the first account; and the trading component further configured to automatically execute the investment purchase. According to one embodiment, the system further comprises a verification interface, wherein the verification interface is configured to access and display cryptographically signed records detailing acceptance of a transfer between the respective nodes or accounts in the reconciliation system responsive to user selection of a verification interface object. According to one embodiment, the verification interface is further configured to analyze and validate the cryptographic signatures and amounts of any transfer between respective nodes. According to one embodiment, the verification interface is further configured to analyze and validate the cryptographic signatures and amounts of any transfer between respective accounts, responsive to selection of a verification interface object. According to one embodiment, the at least one processor is configured to: display a transfer option for user selection; and display a selection option for targeting a respective node within the reconciliation and clearing system; responsive to selection of the respective node, access an associated key for targeting the transaction. According to one embodiment, at least one processor is configured to generate a security display for tailoring user security thresholds. According to one embodiment, a client node executing with the reconciliation and clearing system displays activity information on network communication or processing utilization, wherein the display is responsive to user selection to establish a risk identifier threshold, wherein the threshold establishes an upper boundary for communication traffic. According to one embodiment, the display boundary includes a rectangular shape, an arc portion, or a circular display, and the moveable object is configured to be displayed at positions within the boundary. According to one embodiment, the at least one processor is configured to translate each displayed position within the display boundary to the risk parameter. According to one embodiment, the at least one processor is configured to dynamically display information on the risk parameter as the moveable object is repositioned in the display boundary. According to one embodiment, at least one processor is configured to dynamically translate the risk parameter into a set of candidate investments meeting the defined risk parameter, wherein the at least one processor is configured to calculate and optimize the candidate investments for a cost of liquidation of at least a portion of any candidate investment to meet subsequent transactions (e.g., debits) on the first account. According to one embodiment, at least one processor is configured to analyze user history associated with the first account, and determine future need for liquidity and timing. According to one embodiment, at least one processor is configured to determine the candidate investments responsive to finding a set of investment having a minimal transaction cost relative to other investments having a similar risk that satisfies the determined future need for liquidity and meeting the needed timing. According to one embodiment, the a moveable interface object provides a single selection interface for users to define risk strategy and an investment portfolio.

According to one aspect a system for generating a user interface is provided. The system comprises at least one processor operatively connected to a memory, the memory containing instructions, the instructions when executed that cause the at least one processor to generate the user interface, wherein the user interface is configured to: display an enrollment option screen configured to accept user selection of preference for real-time security investment; display responsive to positive user preference a moveable interface object, the moveable interface object responsive to positioning in the user interface within a display boundary, and is configured to define a risk parameter based on a relative position within the display boundary; upon user input on the moveable interface object, trigger a trading component to define an investment purchase meeting the defined risk parameter, wherein the generation of the investment purchase includes calculation and optimization for a cost of liquidation of at least a portion of the existing securities and the investment purchase to meet subsequent transactions (e.g., debits) on the monetary account; and the trading component further configured to automatically execute the investment purchase. According to one embodiment, the moveable interface object includes a slider and boundary display, and responsive to selection with a visual pointer, display the slider visualization in respective positions within the boundary. According to one embodiment, the at least one processor is configured to translate positioning of the slider within the boundary into the risk parameter. According to one embodiment, at least one processor is configured to display information on risk values associated with a current position of the slider. According to one embodiment, at least on processor is configured to confirm a selection made by a user positioning the slider by displaying information on the risk value associated with the slider current position, and displaying an object in user to commit to the changes in the risk value. According to one embodiment, the a moveable interface object provides a single selection interface for users to define risk strategy and an investment portfolio.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment in any manner consistent with at least one of the objectives, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. Various aspects, embodiments, and implementations discussed herein may include means for performing any of the recited features or functions.

### BRIEF DESCRIPTION OF THE FIGURES

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 shows an example execution platform, according to various aspects and embodiments;

FIG. 2 shows an example process flow and components, according to various aspects and embodiments;

FIG. 3A is an example process for real time securities distribution, according to various aspects and embodiments;

FIG. 3B is an example process for covering debits according to various aspects and embodiments;

FIG. 4 illustrates a user interface for automating investment allocations, according to various aspects and embodiments;

FIG. 5 is block diagram of an example system, according to one embodiment;

FIG. 6 is an example flow for privacy preserving operations, according to one embodiment;

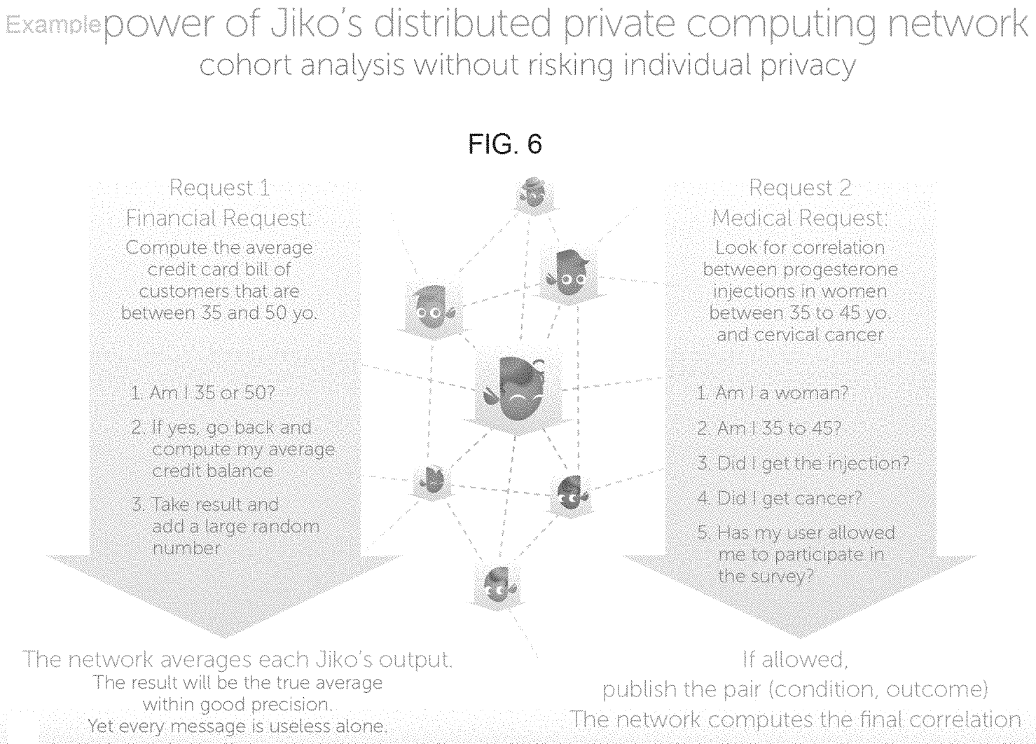

FIG. 7 is an example of functionality implemented on various embodiments;

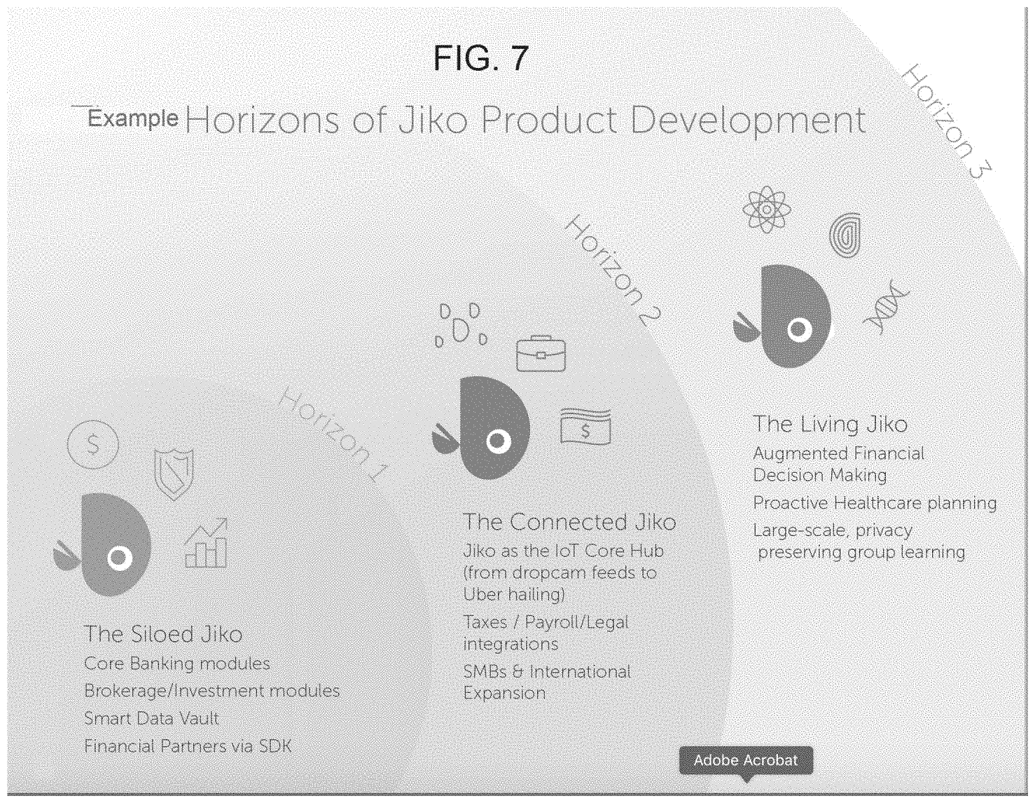

FIG. 8 illustrates an example screen capture and options for initialization, according to one embodiment;

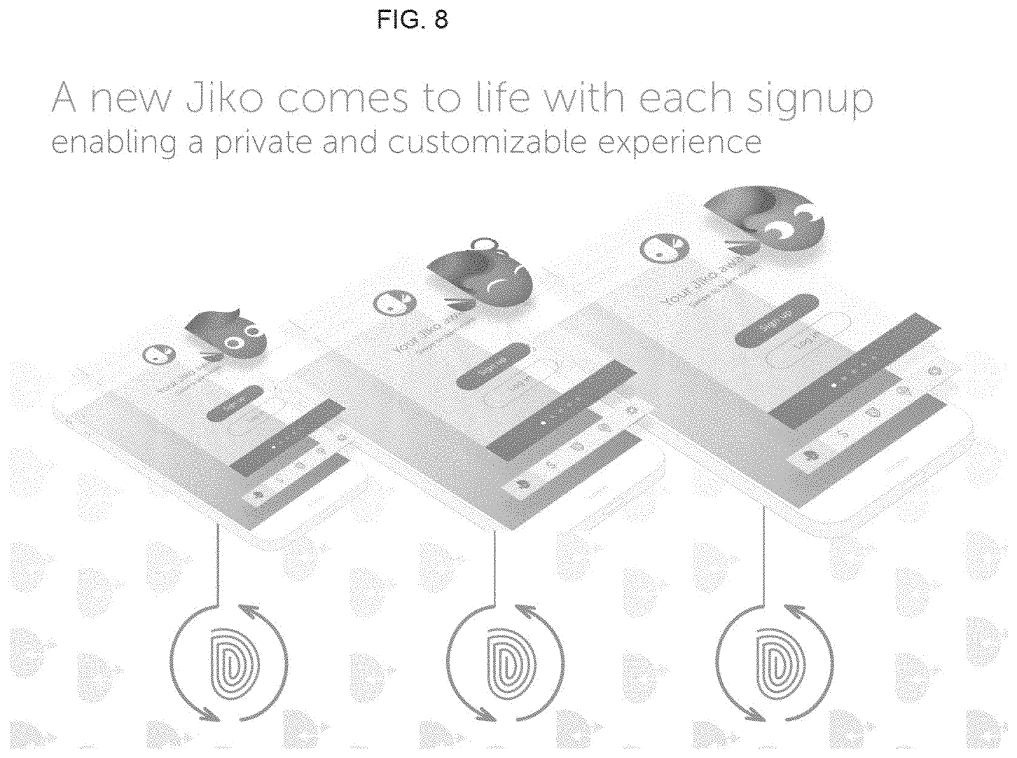

FIG. 9 illustrates an example screen capture, according to one embodiment; and

FIG. 10 illustrates an example screen capture, according to one embodiment.

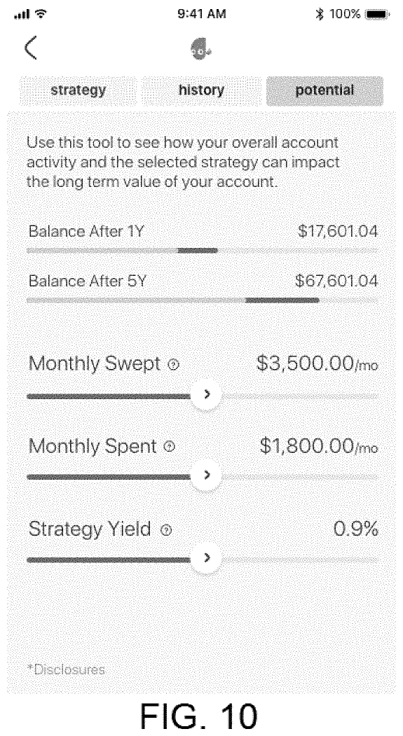

### DETAILED DESCRIPTION

Various aspects and embodiments are directed to methods and systems for node based reconciliation. Various aspects also provide for real-time securities exchange while supporting cash based transactions. Additional aspects incorporate improved user interfaces for enabling single selection investment decisions for a clients' wealth including allocation of all of a client's wealth.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, any combination of, and all of the described terms.

### Example: Node-Level Implementation of a Financial Services Core

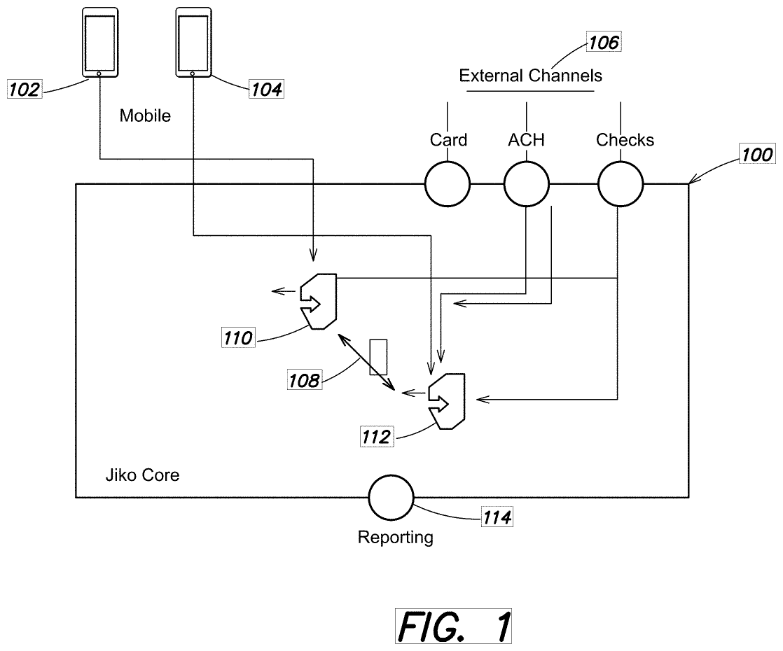

FIG. 1 illustrates an example ecosystem 100 implementing a node based computing architecture, adapted to financial services. According to one embodiment, a node or server (e.g., 110 or 112) is provisioned for a single user or client, by tying the user's credentials (biometrics, password) to a freshly created node (which can be, for example, a newly provisioned cloud resource or a newly instantiated node). According to one embodiment, the architecture is configured to request cloud based resources from known cloud providers whenever a new node is created. Each client node is provisioned with baseline functions (e.g., networking and firewall rules, transactional functions (discussed in greater detail below), databases and backup facilities, secure access for a respective client, administrative access for management, etc.). In further embodiments, the provisioning requests for each node can be made across different cloud providers to ensure resilient distribution. The image for provisioning nodes in such a setting can include secure communication protocols between nodes on different cloud providers.

According to one embodiment, the system is configured to provision a new node for each client as a client registers for the node based computing service. During registration new node are tied to respective clients and for secure and private access (e.g., using biometric identification, username and password combinations, etc.).

In one example, the client can access their provisioned node via any computing device (e.g., mobile devices 102 or 104) attached to a network (e.g. the Internet). The client can then set account information or access their personal and/or financial information. According to one embodiment, the nodes (i.e. the “Jiko nodes”) support the overall functionality of a traditional banking core as part of the baseline functions embedded into the provisioning image—but do so in a markedly different manner. According to some embodiments, the processing of messages (e.g., from external channels 106 (e.g., Card, ACH, Check) or other Jiko nodes and handling of information is private and localized to each users' node respectively. Further, the system can be architected such that external communication channels occurs through system Jiko nodes or administration Jiko nodes and then to client Jiko nodes.

For example, users may initiate a transaction from their computing devices to transfer money to another Jiko node (e.g., from 110 to 112). Arrow 108 illustrates an example transfer which can include registration operations for performing node based transactions (e.g., that may occur between Jiko nodes assigned to specific users or with the external channels 106).

According to one embodiment, registration operation can include two Jiko nodes, or components of Jiko nodes, connected, for example, via HTTPs. The system architecture includes routing mechanisms for these connections to occur between nodes and/or components of node. Ultimately, a channel can be established between a component of a Jiko and another component of another Jiko based on a secure communication protocol.

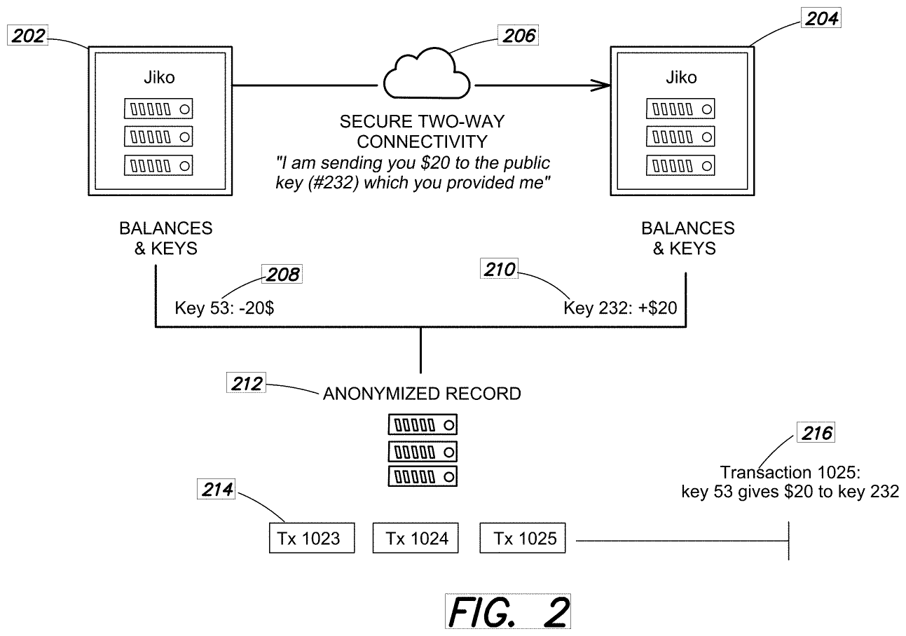

Between Jiko nodes, the architecture executes a primary record at a first Jiko node (registers a transaction and updates a balance on the respective node) and builds an anonymized transaction record for which the two Jiko nodes involved in the transaction post, and sign to validate the transaction. Example transaction executions are discussed greater detail with respect to FIG. 2. In some embodiments, the first Jiko nodes builds an anonymized transaction record reflecting a debit from the first Jiko node (e.g., having debit amount and the first Jiko node Address) and a credit to a second Jiko node (e.g., having a credit amount and the second Jiko node Address). Likewise the second Jiko node can generate a record showing a credit (e.g., having a credit amount and the second Jiko node Address) and a debit from the first Jiko node (e.g., having debit amount and the first Jiko node Address). Both records are digitally signed for verification and posted to enable any observer of the record to validate proper execution. In other examples, the two Jiko nodes can jointly create a record of the transaction and post an anonymous record signed by both nodes.

In further embodiments, the reporting element 114 can provide the services for posting anonymous transaction records. In some embodiments, the anonymized records can be discarded after a period of time.

According to one aspect, the node based architecture (e.g., 100) is fundamentally different from traditional bank core ledgers. For example, the node based architecture does not rely on any centralized database of customer data (e.g., personal and transactional data). As architected, the only repository with a respective customer's identifying data is the respective customer's node. Any component outside of the node wanting to access data (e.g., balances, statements, know your customer information (“KYC”), transaction history, etc.) or process transactions related to that customer needs to interact with the customer's Jiko node and be permissioned. As a result, the platform ‘core’ is significantly harder to compromise than conventional architectures: for example, intrusions are easier to spot since they have to occur on each node (and each node is expected to have minimal traffic—in fact traffic abnormalities can be observed automatically and remedial actions taken in response to traffic abnormalities (e.g., pause transaction execution on node, flag all transactions, require admin node to mediate all traffic to node, etc.); and in another example, system resiliency is significantly improved over conventional architectures, given that at any given time only certain nodes of the system may be down. In some embodiments, the node based architecture includes administrative nodes that can monitor Jiko node communication traffic and flag any excessive communication and/or trigger additional reconciliation operations at such Jiko nodes to ensure security.

Various permission/authentication services can be implemented with respect to the various nodes. In one embodiment, communication to a Jiko node is limited to authorized components and responsive data—thus even for authorized components only certain things will be served back. For example, bank compliance monitoring components are restricted from querying user data that is not logged/produced by the bank module inside the Jiko node—thus user level and/or application level security can be enforced on a node by node basis as well as a system component by component basis. Other thresholds limit various queries or other information requests to ensure security in various embodiments. In another example, large data volume queries are limited such that the system is configured to require executive (e.g., administrative node) approval before execution. And even in such scenarios, individual Jiko nodes and the groups of Jiko nodes making up the network are configured to communicate (anonymously) with each other, and the network is configured to detect various abnormal conditions—e.g., “25% of Jiko nodes are executing a compliance query==>trigger alert (and/or halt query until executive resolution) without any external intervention; and e.g., Node A is saturated with queries (e.g., pause any query executing against Node A, alternatively kill connections established to Node A, etc.).

In addition to security improvements over some conventional banking architectures, various embodiments provide significant advantage over other conventional reconciliation approaches. Namely, the architecture and reconciliation provided herein differs fundamentally from the block-chain architecture and execution, as it does not require proof-of-work to validate a peer-to-peer distributed record of transactions. Further, the current architecture is configured to scale with no environmental concerns (i.e., any number of nodes can be added seamlessly to handle any processing volume or capacity), and the architecture is compatible with existing financial implementations. According to various embodiments, new Jiko nodes can be instantiated without degrading system performance, and integration with the other nodes becomes a function of providing a new wallet address for the newly provisioned Jiko node.

### Example Node-Level Ledger Reconciliation

According to one embodiment, whenever a transaction occurs, the user's node (Jiko) registers (records) that transaction into its own private ledger, and updates an available balance on the node. In one example, the ledger provides value and key pairings (e.g., +20 dollars paired with a key, −20 dollars and key, etc.). In addition to the primary record being stored inside the Jiko node, the system implements a mechanism to handle software glitches, or even potential malware deployed inside a Jiko node that could corrupt the internal balance/record. In one example, the mechanism includes generating an anonymized transaction record on which any two Jiko node executing a transaction post the transaction and sign it. In some embodiments, the approach is executed between two consumer associated Jiko nodes, and in others, the approach is executed between an external channel Jiko node that can manage and/or reconcile requests from external channels (e.g., deposit money to consumer account, or withdraw from consumer account, etc.) and a consumer Jiko node. Another example, provides for transfers between two external channel Jiko nodes. According to one embodiments, operations are executed in a pairwise fashion, where each participant records a private copy of the transaction, and each signs and anonymized transaction record that is posted for review. In some embodiments, administrative Jiko nodes are implemented to handle translations between external channels and consumer associated Jiko nodes. For example, administrative Jiko nodes can include or provision firm-side Jiko nodes that handle special house accounts that face the external world where master accounts are involved. (e.g., corresponding bank master account, card processing settlement accounts, etc.).

According to one embodiment, each Jiko holds addresses (e.g., in a wallet or other secure data element) and upon transfer based on that address to another Jiko, signs the transaction with the relevant key as to ownership, while the other side signs the receipt of the result of the transaction As a result, the system provides a cryptographically secure record of the transaction which is stored in each Jiko, but also in a separate external database that can be reviewed/audited. According to various embodiments, each node generates its key pairs (public/private) and public keys are exchanged with other nodes or external entities—allowing others to verify that something (e.g., secure information exchange or transaction) was signed with the correct private key.

The external database that can be reviewed constitutes a cryptographically secure, yet anonymous repository of key-linked transactions. That record has in particular no counterpart attached to it. Moreover, the record of the transaction also eliminates context from the record. Unlike other approaches, these properties ensure anonymity, but also provide for reconciliation. The actual context of the underlying transaction remains inside the two transacting Jikos. According to other embodiments, Jikos are running reconciliation modules which periodically scan the central record (e.g., housing the anonymized record) and confirm that the addresses which the Jiko used still register the original amount and destination address. In the case of a mismatch, alerts are raised, allowing for real time detection of corruption.

Example records in the database include a scenario where Jiko 1 and Jiko 2 agree to transact, whereby Jiko 1 pays Jiko 2 for a specific good. The information that Jiko 1 will store in its ledger will include the entire transaction: ‘I bought 5 loafs of bread from John for 2$. I settled with John by transferring 2$ from my xxx address to the address he provided me, e.g., zzz”. Jiko 2 will store the reverse. According to various embodiments, the anonymous record however will only see ‘2$ exchanged from address xxx to address zzz”—i.e. an central records with the context of the transaction removed.

FIG. 2 illustrates an example process flow and system elements involved in executing a transaction. At 202 a first Jiko node, establishes a secure two-way connection 206 to a second Jiko node 204, for example, via a secure peer-to-peer connection. In one embodiment, a connection is established by user nodes exchanging at first enough information (addresses, keys) to enable the Jiko nodes to establish a proper hand shake. Jikos (e.g., 202 and 204) can access wallets of addresses via centralized anonymous and temporary records to manage communication. Jiko nodes (e.g., 202 and 204) transact by shaking hands based on the addresses retrieved. In this example, Jiko node 202 initiates the transaction and records the transaction debit and credit in its private ledger (e.g., at 208—key 53: −$20 & key 232: +$20) and updates an available balance for the node. Jiko node 204 records the transaction 210 in its private ledger (e.g., as keys 53: −$20 and key 232: +$20) and updates its available balance. During the transaction the sending Jiko node (e.g., 202) releases (via cryptographic signature) the corresponding sum across addresses in the local wallet to a destination address that was given by the other Jiko node during the handshake process. The release is executed via a push onto the validation record described above 212 (e.g., posted anonymous transaction record). This is in addition to recording the transactions in the respective private ledgers of the Jiko nodes—(e.g., at 214 transaction 1023, 2014, and 1025). The records include specification of the transaction based on value and key (e.g., at 216: Transaction 1025: key 53 gives $20 to key 232).

Each Jiko node is configured to periodically or a-periodically reconcile its current balance stored in its private ledger against the central record. In some examples, each Jiko node checks the central record to confirm that the addresses (specified by key) register the amount specified in the private transaction ledger, and also match addresses of the private records.

According to some embodiments, various elements of the node based architecture provide the operating platform on which transactions execute, are reconciled, and are validated periodically for issues. According to one embodiment, the components of the system include: (1) Jiko nodes configured to store their own ledger and which are the sole repository of the entirety of a customer's transaction data; (2) Jiko nodes configured to transact by shaking hands—one initiates the other agrees via a direct p2p connection; (3) A receiving address provided by the receiving Jiko node to which the sending Jiko node will release the monies to (4) A central record where cryptographic transfer of assets from one address to another one are recorded 5) algorithms inside each Jiko node to periodically check against the record sum of all addresses owned by the Jiko, the official transactions registered by the Jiko node internally—where again, only the Jiko node knows that a key is associated with the respective Jiko.

According to some embodiments, each Jiko node is configured to build and store its own wallet of addresses. For each new transaction where a Jiko node RECEIVES something: the node is configured to create a new address, provide the public key, where the deliverer can transfer ownership of things to that address. For example inside a Jiko node, there are many addresses that the Jiko node can spend from (and each with a specific balance on the central record). Among the Jiko node's functions included are operations executed to make sure that the sum of all those balances (one per address) is equal to what the Jiko node sees based on his own record of all that happened.

According to further embodiments, the centralized records for transactions are anonymized, in that only key and transaction value are recorded. The key used by the respective Jiko nodes are selected to prevent pattern analysis or implication of identity. In one example, Jiko nodes can rotate their keys periodically or on random intervals to further secure anonymity. Additional embodiments include extensions to non-cash ledgers, e.g. reconciliation of securities ledger, including corporate action processing such as dividends and coupons payoffs. According to one example, Jiko nodes can use new addresses and keys for each transaction, in other examples, the changes to address can occur at on frequency, and changes to keys at another frequency. The rotating nature of the keys and address provides greater security in the node based system than conventional approaches.

### Example Methods for Real-Time Deployment of Cash

According to another aspect, the node based architecture can be configured to manage real-time cash deployment of held balances into securities. According to one embodiment, each Jiko node can operate a broker/dealer component which is enabled to execute security trades and also able to pull balances from the user's bank account. According to one embodiment, end users can enable cash deployment functionality on their node responsive to selection in a UI display. For example, a Jiko node can be provisional initially without the cash deployment functionality, and responsive to user selection in the display, a SDK module is installed. Once installed, the cash deployment functionality can be executed automatically to manage available cash deposits and invest them into securities according to preferences defined by the Jiko user. In other examples, the functionality can be available, but inactive. The user can choose to activate the functionality via the user interface and respective display. According to various embodiments, cash balances can be funneled into securities by executing transfers from the user's bank account (which is also operated inside the Jiko) to the user's broker dealer account. In some examples, a bank module communicates with a securities module both executing within the Jiko to effect the transfer of cash to a securities module that purchases respective securities. Each module can be limited in permission and access control to facilitate security even where the modules execute on the same Jiko node.

In one example, each Jiko node (e.g., 202 or 204) that is configured for real-time securities exchange is established with at least two accounts: a bank account that handles cash and payment transaction (e.g., ACH payments, debit payments, and also transfers of cash into the brokerage account as described above), and a broker/dealer account. In response to a transaction request, the bank component or transaction processing component can query the broker/dealer account for a quote on the value of the current portfolio or holdings. If the holdings are of sufficient value, a transaction layer (e.g., including the transaction component) requests that the broker/dealer execute a sufficient (and optimal) liquidation trade to free up cash value for use in the bank account to honor a payment. In some embodiments, the transaction layer can specify the details of an optimal transaction, or provide a minimum value to the broker/dealer which determines an optimal transaction based on user defined preferences (e.g., user input on risk preference, statistical behavior, etc.). According to some embodiments, the transfers between accounts (e.g., bank account and broker account) can be managed similar to monetary transfer between Jiko nodes discussed above. In one example, each account creates its own private record of the transfer of cash, and each account signs (with a respective key) an anonymized posted record for validation.

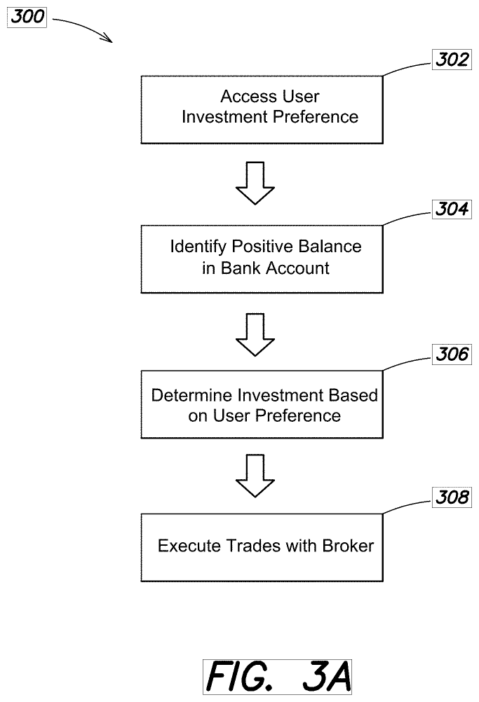

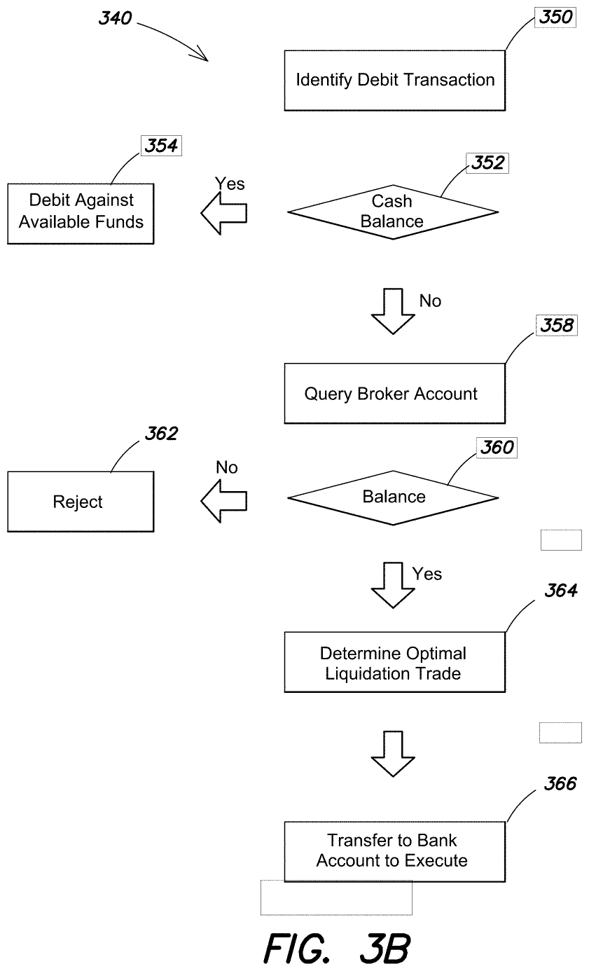

FIG. 3A illustrates an example process for real-time securities deployment 300. Process 300 begins at 302 with accessing user investment preferences. According to various embodiments, any user or bank account holder can specify whether or not they wish to participate in real time securities investments. Further, users can specify their investment strategy through a user interface element for selecting a risk tolerance. In some examples, a user slides a visual indicator along a bar showing on one end low tolerance for risk and on the other end high tolerance for risk. In further examples, as a user slides a visual pointer along the bar, the user interface can display example investments that correspond to the visually selected risk constraint. In another example, the user interface can include a dial that allows the user to select a level of risk tolerance by rotation the visual display via a visual pointer in the user interface.

If the user preferences indicate that security investments are permitted or the user is enrolled in real time security investments, process 300 continues at 304 with identification of a positive balance in the user's bank account. Based on the available balances, and the user's preference for risk (and, for example, any other holdings), the Jiko node (including for example, a transaction layer and/or a broker layer or component) can determine an optimal investment for the available funds at 306. In some embodiments, the optimal investment determination can be configured to account for statistical behavior of the account holder (e.g., hold large balance for long period—this opens up the possibility of optimal investments (e.g., calculated by the algorithm) that include more expensive security transactions, as opposed to a customer with balances that fluctuate quickly and often—the algorithm is configured to identify smaller transaction fee options or higher liquidity investments, for example). Once the optimal investment is identified (e.g., bonds, stocks, ETFs, mixtures, etc.) process 300 continues at 308 with execution of the corresponding trades (and a zeroing of the bank account balance).

Process 300 can be paired with a process for reversing investments to cover debits against the now zero balance or insufficient balance bank account. FIG. 3B shows an example process 340 for covering debits against bank account paired with real time securities investment accounts. In some embodiments, process 340 is executed automatically to cover transaction and respective amounts. For example, process 340 can begin at 350 with the identification of a debit transaction. In some examples, a user may initiate the transaction to transfer funds or in another example, the user may have authorized a debit against their account. Once the debit is identified, the current cash balance may be checked to determine if the transaction can proceed without access to the broker account (e.g., 352 YES—sufficient funds leads to transaction execution as discussed above (private ledger and anonymous transaction record) at 354). If not 352 NO, process 340 continues with executing a query against the broker account or broker/dealer to determine if the broker account is of sufficient value at 358.

If there is not sufficient value 360 NO, then the transaction is rejected at 362. If there is sufficient value 360 YES, process 340 continues with determination of an optimal liquidation trade at 364. For example, the optimal liquidation trade is calculated to maintain the user's preferences on risk for any remaining investments, and/or to minimize any expenses associated with the liquidation trades (in some examples the Jiko node brokerage execution provides liquidity in trading with no fees—in which case the optimization algorithm can be configured to ignore expense as an optimization factor). Upon liquidation of investments a corresponding value can be transfer from the broker account to bank account held at the Jiko node at 366—in some examples the transfer of funds from the broker account to the bank account (and vice versa) can proceed as discussed above between two Jiko nodes (e.g., updating private ledgers for both accounts and can include posting of an anonymized central record). Various embodiments thus enable cash balances to be held as securities, and automatically liquidated to process incoming transactions. Further implementation evaluates both the current holdings for a client, optimal (e.g., minimal transaction cost) liquidation expense, and remaining holdings for compliance with risk allocation. In some examples, the system can identify a minimal cost liquidate strategy, execute, and then rebalance security holdings to return the holdings to compliance with any defined risk threshold.

Example Pseudo Code Execution

```
Transaction(incoming)
{ event = transaction.debit  // first pass can use estimation to determine if more
                            // detailed analysis warranted
  estimate. curr_holdings // access client broker account and evaluate
                            // current securities for value
                            // optional estimate transaction cost for liquidation
  // optional // estimate.trnscost  // call cost estimation function for selling assets id
                            // asset class and retrieve average cost per txn
                            // brute test - coarse estimate $.10 per transaction
    if estimate.curr_holding > transaction.debit.value
      then optimal.sale ( )
        if liquid.value < debit.value
          find(min) eval txn.cost and assetname.val and
          risk.param // some examples use breadth first search
                  // through graph of curr.risk, txn.cost, and
                  // asset.name
          update risk.param // for remaining assets
          do include assetname.val with txn.cost
          if total.assetname.val > debit.value store candidate.sale
              // optional eval candidate, sale. <num> find(min)
              // risk.param deviation
          end
}
```

### Example Single-Touch Investment Configuration

In one example, each client (and associated Jiko node) has an account at the bank and an account at the broker-dealer (BD account). The two accounts have their ledgers stored inside the client's node (Jiko node). The Jiko node powers an algorithm that monitors both balances and makes investment decisions on behalf of the customer and maintains liquidity in the accounts for payments required by the user. When money is deposited into the bank account, the algorithm (running inside the node) identifies it as a deposit and instructs the ledger to move the money from the bank to the BD account. The algorithm then runs an optimization analysis to compute the optimal portfolio of securities (bonds, stocks, ETFs) to hold based on the user's inputs, risk preferences, and statistical behavior. The algorithm then executes on behalf of the user a trade to purchase these securities against the ‘market’ which the user is facing via the broker-dealer. At this stage, the client is fully invested with no cash in the bank and no cash in the brokerage account.

When a payment needs to be processed by the bank, the bank layer has the ability to query the brokerage account for a quote on the value of the portfolio. If the portfolio has enough value, the trading algorithm executes an optimal liquidation trade and frees up cash that appears on the client's account at the brokerage. The money is then automatically transferred into the bank account, and used to honor the payment. In some examples, the investment and return transfers are done nearly instantly (“nearly instantly” including the computation time for reconciling transactions), transactions occur inside the node and the composition of a client's portfolio remains private, and clients know at all times where their money is invested providing a dramatic improvement over FDIC insured deposits.

According to another aspect, the node based architecture can be configured to manage real-time cash deployment of held balances into high yield securities. Generally, the Jiko node and respective investment algorithms can enable a one touch user interface display that allows a user to determine in a single-action how to deploy his or her entire wealth—and for example, his or her wealth distributed across payment and brokerage accounts.

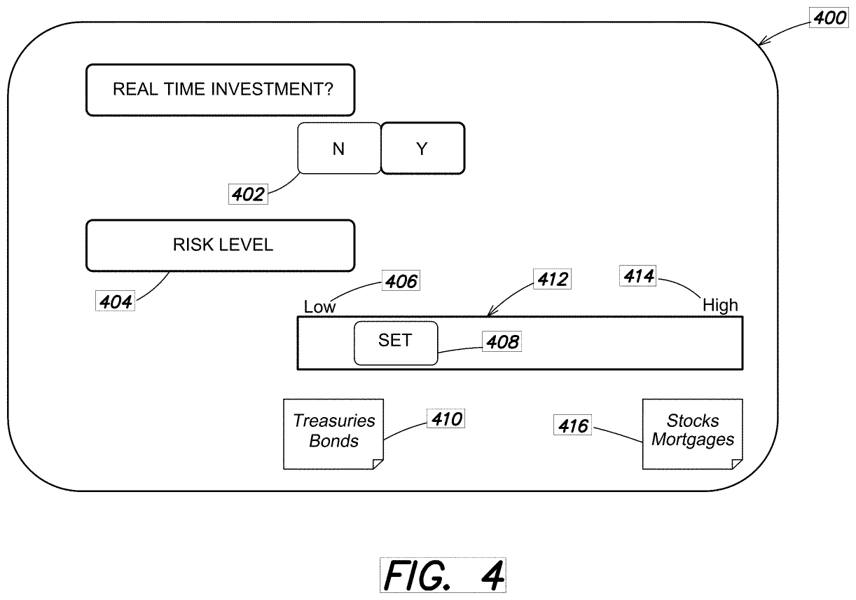

In various embodiments, the ability to deploy cash into securities and reversing securities to cash upon payment debit needs is configured via highly intuitive displays for the user. FIG. 4 shows an example portion 400 of a display screen. Clients can access their accounts and set their preferences for investments. In one example, the system requires an initial decision of whether to participate in real-time investing. In FIG. 4, a client can toggle a visual switch in the user interface at 402 to enable or disable real-time investing. In some examples, a terms window and a required confirmation of the decision can be displayed in response to a user interface selection to enable real-time investments. In some examples, the user interface is configured to prompt the user responsive to disabling real time investment functions whether they wish to liquidate any current holdings. Response to a yes/no selection (not shown) the system can automatically liquidate existing securities or other holdings to convert the assets to cash balances. In one alternative, existing assets can be maintained with real time investing disabled, and new cash balances then remain in the user's bank account.

As part of enabling real-time investments, the client must select a risk level (e.g., shown at 404). In some examples, the user interface is configured to display a splash a notification indicating the requirement to select a risk level in order to start real-time investment. In one embodiment, the default display setting is shown at 408 as a visual lever or button that can be manipulated in the user interface. The button or level can be transitioned along path 412 to establish a desired risk level. Such one touch investing interfaces provide significant advantage over conventional approaches. According to some embodiments, the system's executional efficiency is significantly improved via the one touch interface, for example, over conventional system where user must specify individual investments or input percentage investments in various vehicles. In further embodiments, the streamlined user interface reduces user selection error. For example, the user simply slides a visual lever to the left or right to set their risk preference and the system automatically allocates investment on the user's behalf. Notably, such investment decisions are fraught with user error in conventional system as users are expected to evaluate investment vehicles, identify individual securities, set their own percentages, among other onerous tasks. The burden, of such selections often limits participation in and adoption of conventional approaches.

In some embodiments, a display bubble is configured to appear when a new risk level is selected in the user interface or responsive to a hover event over the button (e.g., via a visual pointer). One example display bubble is shown at 410. The display bubble at 410 specifies a type or class of investment that corresponds to the risk level selected. In other examples, the display bubble can include an expected rate of return (and may include a disclaimer about past performance). Shown at 414 is hypothetic selection of high risk and associated bubble 416—that would be display if a client slides button 408 in the user interface along path 412 to the high setting at 414.

According to some aspects, the system is configured to provide automatic investment opportunities, while preserving anonymity in those investments. As discussed above, transactions and holdings can remain anonymous. Anonymity and privacy in these setting facilitate improved security and further adoption of the such functions.

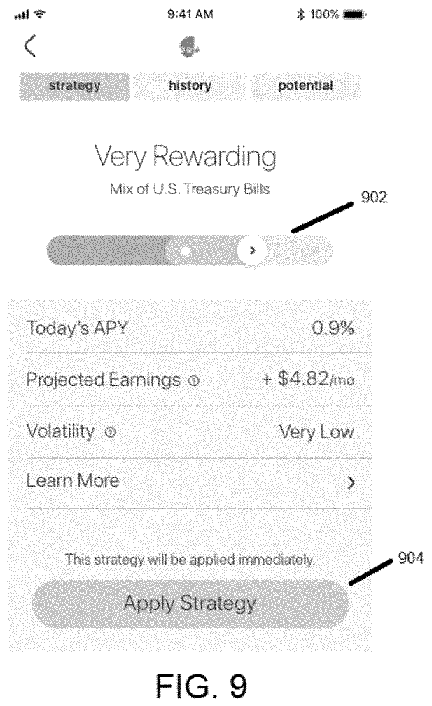

Various embodiments are configured for single touch portfolio selection. For example, responsive to manipulation of a risk indicator in the user interface, all remaining decisions on investment selection are made automatically on behalf of the client. Shown in FIG. 9 at 902 is a risk selector. According to some embodiments, the system can be configured to request or require a confirmation of a selection risk—which can be submitted by the user via display 904. The system enables the client to choose a risk level by adjusting a single lever on the screen.

According to one embodiment, a mobile app interfaces with a private dedicated server (the client's node) which is running an algorithm which optimizes the optimal portfolio to invest the client's wealth as a function of various inputs, such as the client's history, preference parameters, etc. The calculations are performed in real time and trigger a response to the app with the maximum risk (in an appropriate measure) and maximum return (over an appropriate horizon chosen by the client in the user interface) in what appears to be real time to the user. Each of the prior determinations can be informed (e.g., weighted against) by available user history (e.g., frequent debit transactions (e.g., target low transaction cost investments), large stable balance (e.g., weight optimization to return AND tolerate higher transaction cost assets, etc.) When the user confirms a level that fits his needs, he releases the dial or lever and the corresponding trade or rebalancing trade is executed by an algorithm, for example, hosted and executed on the server side.

Example Applications of Jiko Architecture

As discussed above, the Jiko node per user architecture enables privately held data to remain on a Jiko node, but at the same time permits noisy responses from the Jiko nodes to use the private date without compromising individual security (even for example when intercepted and further even when intercepted in the clear). According to various embodiments, extensions of that architecture provides for general big data calculations while ensuring individual privacy, for example, where a data scientist wants to compute specific statistics (like the correlation between age, location, ethnicity and some things like profitability, or credit defaults etc.). As the nodes store the private information, and produce noisy answers to requests which, individually are useless, but combined recreate useful numbers.

Further embodiments, enable application of the node architecture to a share-driving entity (e.g., Uber) storing all the client information (location, trip details, cancellation history, etc.) in the nodes. By polling the respective nodes for the private data (made noisy via random values) and analyzing or calibrating the overall cab hailing algorithms to ensure that the fleet is efficient (i.e. more drivers around specific zip codes at specific times and in additional examples that is more responsive to users of type A who tend to pay better) all WITHOUT ever having access to any personal information and anyone with higher level privileges (e.g., DB sysadmin) restricting access to certain tables. Enabling noisy responses based on private data represent a departure from conventional approaches that limit access to private data to only those users or processes that are explicitly authorized. This departure from conventional processing simplifies the computer architecture and eliminates potential security failures of conventional systems. For example, flawed permissioning generates as many security leaks as malicious hacking events.

According to other embodiments, the system can enable credit & insurance providers to run proprietary software inside a client Jiko node. For example, the software can provide a client with a quote that uses local data to precisely calculate a customized rate—but because the software runs inside a Jiko client node, the node prevents any external communication of the private information. Thus, a tailored quote is available to the client yet without anyone at those institutions having access to client data directly. Again, this approach provides a significant departure from how computer systems process these request online, where the conventional systems attempts to provide more and more security around personal data held by the third party—a significant shift from such approaches allows the Jiko node to hold and retain that private data and yet allows the third party software to utilize that information. Further, such providers and the data teams can then query the fleet of Jikos as above, to perform mathematical calculations, extract default rates, etc. as the Jikos store the history in their private records (I paid every month, but this month I defaulted) and can, as a network, answer things such as ‘are males 24 to 34 who like to video games more likely to default on a car payment than X’ without compromising individual security.

In yet other embodiments, the Jiko node architecture can facilitate advertising as well. For example, marketing agencies can query Jiko nodes (e.g., sending messages) for ‘people under 35, who like outdoors and do this example activity and another example activity’. The relevant Jiko nodes subscribe to feeds, filter what is applicable, and then for nodes and users who opted-in are communicated highly customized content. In various embodiments, until the end user associated with the Jiko node acts on an ad, the marketer/vendor doesn't even know the node exists. Again, this reversal of conventional delivery and execution provide an environment that is the opposite of the current world approach where all a user's data (and other's) are uploaded into systems who then analyze that data and determine where to use the information, and further must secure the same data against malicious attack as well as inadvertent disclosures.

In still other embodiments, the Jiko architecture can serve as a platform for a health care system. For example, a client can store DNA information in a private ledger or record and all client personal information. Then let the Columbia university do a cancer research (e.g., executed queries on Jiko nodes) on effects of ‘injecting dose X of hormone Y into pregnant women, on having uterine cancer before age 40’ (which represents a real use case of the Jiko node architecture). It is realized that conventional approach have failed to collect the massive amount of data available to aid such research. In other words, there is not enough data out there right now, because people don't trust institutions enough because everything (e.g., personal data) is always commingled. In the Jiko node architecture, everyone's data is private, and not leaked or mingled with other sources or made available to other data consumers. Yet all Jiko nodes can be configured (e.g., via subscription or monitor services) could be listening to accredited health care research feeds, and in case where the user is a woman who has received that hormone while pregnant, that user's Jiko node could participate in an anonymous survey, and if the users agrees, put the user directly in touch with Columbia's medical research arm. It is realized that the underlying distributed, privacy preserving architecture of the current system allows science moves faster, and while user data remains protected. This is particularly relevant in an age where DNA sequencing is so advanced.

### Example Computer System

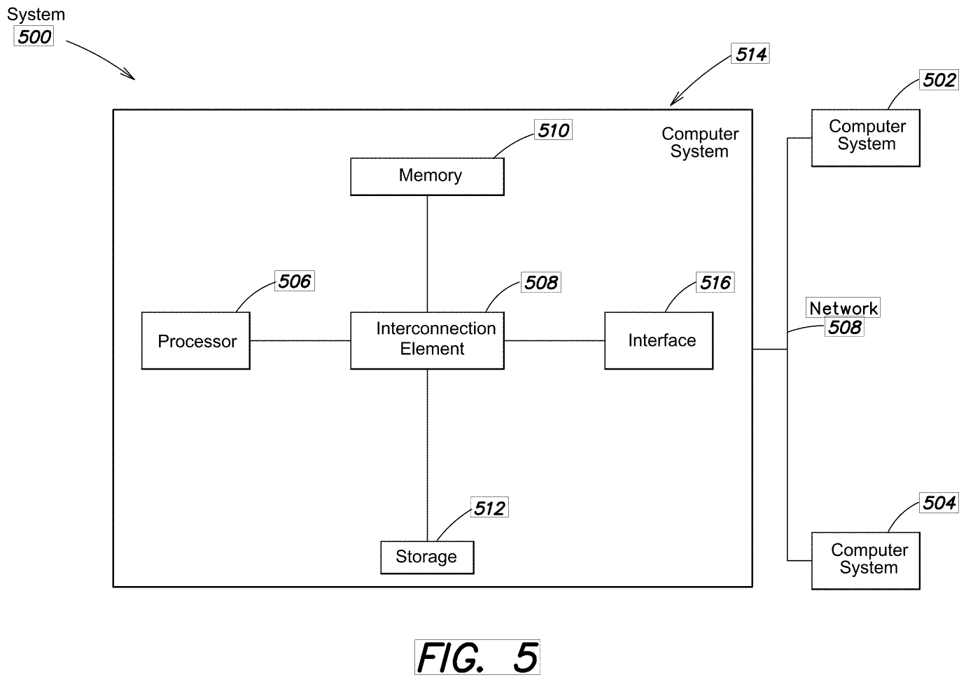

FIG. 5 illustrates an example a block diagram of a special purpose computer system which can be specially configured to execute the functions, operations, and/or processes disclosed herein. For example, the system 500 can host Jiko nodes, provision Jiko nodes, or be communicatively coupled to a Jiko node (for example, with a database with customer information, (e.g., account and brokerage information on a Jiko)), the node can host addresses for other Jikos, and execute transfers between Jiko nodes as discussed above. The system 500 can be configured to operate special Jiko nodes that connect external channels (e.g., ETF, Check, Credit Card Networks) and transform deposits or debits into Jiko key and value requests made on other Jikos. In some embodiments, the system can manage access and interaction between multiple mobile devices and respective Jiko nodes. The system 500 can be implemented on or configured to connect with cloud computing resources such as, for example, Amazon Elastic Cloud 2 (EC2).

The system 500 can include one or more a computer systems 514, 502, and 504. The computer system 514 can include for example a special purpose computing platform that includes processors such as those based on Intel PENTIUM-type processor, Motorola PowerPC, Sun UltraSPARC, Texas Instruments-DSP, Hewlett-Packard PA-RISC processors, or any other type of processor. System 500 can include special-purpose hardware, for example, an application specific integrated circuit (ASIC) for executing the operations, functions, and/or processes discussed herein. Various aspects of the present disclosure can be implemented as specialized software executing on the system 500. For example, the system can be configured to manage the transfer of funds between Jiko, automatic and real-time investment in securities, etc.

The system 500 can include a processor/ASIC 506 connected to one or more memory devices 510, such as a disk drive, memory, flash memory or other device for storing data. Memory 510 can be used for storing programs and data during operation of the system 500. Components of the computer system 500 can be coupled by an interconnection mechanism 508, which can include one or more buses (e.g., between components that are integrated within a same machine) or a network (e.g., between components that reside on separate machines). The interconnection mechanism 508 enables communications (e.g., data, instructions) to be exchanged between components of the system 500.

In some embodiments, the system 500 can also include one or more computer systems 502 and 504, which can include for example, a keyboard, a display, or a touch screen. In addition, the computer system 500 can contain one or more interfaces 516 that can connect the computer system 500 to a communication network, in addition or as an alternative to the interconnection mechanism 508.

The system 500 can include a storage system 512, which can include a computer readable and/or writeable nonvolatile medium in which signals can be stored to provide a program to be executed by the processor or to provide information stored on or in the medium to be processed by the program. The medium can, for example, be a disk or flash memory and in some examples can include RAM or other non-volatile memory such as EEPROM. In some embodiments, the processor/ASIC 506 can cause data to be read from the nonvolatile medium into another memory 510 that allows for faster access to the information by the processor/ASIC 506 than does the medium. This memory 510 can be a volatile, random access memory such as a dynamic random access memory (DRAM) or static memory (SRAM). It can be located in storage system 512 or in memory system 510. The processor/ASIC 506 can manipulate the data within the integrated circuit memory 510 and then copy the data to the storage 512 after processing is completed. A variety of mechanisms are known for managing data movement between storage 512 and the integrated circuit memory element 510, and the disclosure is not limited thereto. The disclosure is not limited to a particular memory system 510 or a storage system 512.

The system 500 can include a special purpose computer platform that is programmable using a high-level computer programming language. The system 500 can be also implemented using specially programmed, special purpose hardware (e.g., an ASIC) and can include a specially configured mobile device (e.g., a smart phone). The system 500 can include a processor/ASIC 506, which can be a commercially available processor such as the well-known Pentium class processor available from the Intel Corporation. Many other processors are available. The processor/ASIC 506 can execute an operating system which can be, for example, a Windows operating system available from the Microsoft Corporation, MAC OS System X available from Apple Computer, the Solaris Operating System available from Sun Microsystems, or UNIX and/or LINUX available from various sources. The system can also execute a mobile operating system which can be, for example, Android, iOS, Windows Phone, and BlackBerry OS. Many other operating systems can be used.

The processor and operating system together form a computer platform for which application programs in high-level programming languages can be written. It should be understood that the disclosure is not limited to a particular computer system platform, processor, operating system, or network. Also, it should be apparent to those skilled in the art that the present disclosure is not limited to a specific programming language or computer system. Further, it should be appreciated that other appropriate programming languages and other appropriate computer systems could also be used.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure, and are intended to be within the scope of the examples discussed herein. Accordingly, the foregoing description and drawings are by way of example only.

What is claimed:

1. A real time transaction processing system, the system comprising:
a node configured to access a monetary account and a broker account, wherein the node is configured to:
in response to a request to execute a first transaction to debit a first value from the monetary account, perform processing comprising:
generate a liquidation trade for the broker account that, when executed, provides a second value in the broker account;
trigger execution of the liquidation trade to obtain the second value in the broker account; and
transfer, from the broker account to the monetary account, the second value obtained from execution of the liquidation trade, wherein the transfer enables execution of the first transaction to debit the first value from the monetary account.

2. The system of claim 1, wherein the node is further configured to:
determining whether the monetary account has a balance to purchase one or more assets for the broker account; and
in response to determining that the monetary account has the balance, executing a trade to purchase one or more assets for the broker account using at least a portion of the balance.

3. The system of claim 2, wherein the node is further configured to store a record of the executed trade to purchase the one or more assets in an anonymized ledger, the storing comprising:
storing information indicating a transfer of the at least the portion of the balance from a first address anonymizing the monetary account to a second address anonymizing a previous owner of the one or more assets.

4. The system of claim 2, wherein executing the trade to purchase the one or more assets in the broker account using the at least the portion of the balance comprises:
determining, for a candidate trade, a risk metric for the one or more assets;
determining that the risk metric matches a risk preference defined by a user who owns the broker account; and
executing the candidate trade in response to determining that the risk metric matches the risk preference.

5. The system of claim 1, wherein the node is further configured to:
determine whether the monetary account has insufficient funds for execution of the first transaction to debit the first value from the monetary account; and
perform the processing in response to determining that the monetary account has insufficient funds for execution of the first transaction to debit the first value from the monetary account.

6. The system of claim 1, wherein the processing further comprises:
determining whether the broker account includes securities of sufficient value to enable execution of the first transaction; and
generating the liquidation trade for the broker account in response to determining that the broker account includes securities of sufficient value to enable execution of the first transaction.

7. The system of claim 1, wherein generating the liquidation trade for the broker account comprises generating a liquidation trade that minimizes liquidation cost.

8. The system of claim 1, wherein generating the liquidation trade for the broker account comprises generating a liquidation trade that matches a risk preference defined by a user who owns the broker account.

9. The system of claim 1, wherein the node is configured to perform the processing prior to completion of the first transaction.

10. The system of claim 1, wherein the node is configured to perform the processing nearly instantly.

11. The system of claim 1, wherein the node is further configured to store a record of the transfer of the second value from the broker account to the monetary account in an anonymized ledger.

12. The system of claim 11, wherein storing the record of the transfer of the second value from the broker account to the monetary account in the anonymized ledger comprises:
storing information indicating a transfer of the second value from a first address anonymizing the broker account to a second address anonymizing the monetary account.

13. A method of processing a transaction in real time, the method comprising:
using a processor to perform:
in response to a request to execute a first transaction to debit a first value from a monetary account, perform processing comprising:
generating a liquidation trade for a broker account that, when executed, provides a second value in the broker account;
triggering execution of the liquidation trade to obtain the second value in the broker account; and
transferring, from the broker account to the monetary account, the second value obtained from execution of the liquidation trade, wherein the transfer enables execution of the first transaction to debit the first value from the monetary account.

14. The method of claim 13, further comprising:
determining whether the monetary account has insufficient funds for execution of the first transaction to debit the first value from the monetary account; and
performing the processing in response to determining that the monetary account has insufficient funds for execution of the first transaction to debit the first value from the monetary account.

15. The method of claim 13, wherein the processing further comprises:
determining whether the broker account includes securities of sufficient value to enable execution of the first transaction; and
generating the liquidation trade for the broker account in response to determining that the broker account includes securities of sufficient value to enable execution of the first transaction.

16. The method of claim 13, wherein generating the liquidation trade in the broker account comprises generating a liquidation trade that minimizes liquidation cost.

17. The method of claim 13, wherein generating the liquidation trade for the broker account comprises generating a liquidation trade that matches a risk preference defined by a user who owns the broker account.

18. The method of claim 13, further comprising performing the processing prior to completion of the first transaction.

19. The method of claim 13, further comprising storing a record of the transfer of the second value from the broker account to the monetary account in an anonymized ledger.

20. The method of claim 19, wherein storing the record of the transfer of the second value from the broker account to the monetary account in the anonymized ledger comprises:
storing information indicating a transfer of the second value from a first address anonymizing the broker account to a second address anonymizing the monetary account.
